(19) United States
(12) Patent Application Publication
(10) Pub. No.: US 2026/0254165 A1
(43) Pub. Date: Aug. 27, 2026

(54) ENERGY-STORAGE CONNECTOR ASSEMBLY

(71) Applicant: ADVANCED-CONNECTEK INC., New Taipei City (TW)

(72) Inventors: Pin-Yuan HOU, New Taipei City (TW); Chung-Han Tsai, New Taipei City (TW)

(21) Appl. No.: 19/548,044

(22) Filed: Feb. 24, 2026

(30) Foreign Application Priority Data
Feb. 24, 2025 (TW) 114201877

(51) Int. Cl. H01R 13/631

(52) U.S. Cl. CPC H01R 13/631

(57) ABSTRACT

An energy-storage connector assembly includes a plug connector and a receptacle connector. The plug connector includes a first housing, a locking component, and a first conductive terminal. The first housing includes an accommodation space, a mating groove in communication with the accommodation space, and a first mating portion in the mating groove. The locking component includes a switch member and an elastic member pivotally connected to the accommodation space. Two ends of the switch member include a hook portion and a tap portion. The receptacle connector includes a second housing and a second conductive terminal. The second housing includes a base portion and a second mating portion outward protruding beyond a side surface of the base portion. The second mating portion is adapted to be inserted into the mating groove. The second conductive terminal is retained in the second mating portion and adapted to contact the first conductive terminal.

### CROSS-REFERENCE TO RELATED APPLICATION

This non-provisional application claims priority under 35 U.S.C. § 119(a) to Patent Application No. 114201877 filed in Taiwan, R.O.C. on Feb. 24, 2025, the entire contents of which are hereby incorporated by reference.

### FIELD OF THE INVENTION

The instant disclosure relates to an electrical connector, in particular, to an energy-storage connector assembly.

### BACKGROUND

Electrical connectors refer to connection components and accessories thereof for electrical signal. Electronic devices are mated with each other for signal transmission through cables as well as through the mating between plug connectors and receptacle connectors; in other words, the electrical connectors are also bridges for signal transmission. The electrical connectors are widely utilized in automotives fields, industrial applications, transportation fields, energy fields, and the like. As to the energy fields, electrical connectors are widely used for energy-storage connectors.

In general, an energy-storage connector assembly known to the inventor includes a plug connector and a receptacle connector adapted to be mated with the plug connector. The extension direction of the cable can be fixed through the mating between the plug connector and the receptacle connector, so that the electrical connection between electronic devices can be established. However, as known to the inventor, upon detaching a plug connector with press-type locking device from the receptacle connector, the locking device of the plug connector has to be pressed hard to release the receptacle connector from the engaging member of the plug connector. As a result, the operation of such plug connector is inconvenient.

### SUMMARY OF THE INVENTION

In view of these, an energy-storage connector assembly is to be provided, in which the locking component allows the user to release the locking between the connectors through a simple and Ergonomically manner.

In one embodiment, an energy-storage connector assembly comprising a plug connector and a receptacle connector is provided. The plug connector comprises a first housing, a locking component, and a first conductive terminal. The first housing comprises an accommodation space, a mating groove in communication with the accommodation space, a first mating portion in the mating groove, and a shaft portion in the accommodation space. A side surface of the first housing has an opening. The locking component is in the accommodation space and comprises a switch member and an elastic member. Two ends of the switch member respectively comprise a hook portion and a tap portion, the hook portion is movably engaged in the mating groove, the tap member is movably exposed from the opening, the switch member and the elastic member are pivotally connected to the shaft portion, respectively, the elastic member is between the switch member and an inner wall of the accommodation space, and two ends of the elastic member respectively abut against the inner wall of the accommodation space and the switch member. The first conductive member is retained in the first mating portion. On the other hand, the receptacle connector comprises a second housing and a second conductive terminal. The second housing comprises a base portion and a second mating portion outward protruding beyond a side surface of the base portion. The second mating portion is adapted to be inserted into the mating groove and movably engaged with the hook portion. The second conductive terminal is retained in the second mating portion and is adapted to contact the first conductive terminal.

In some embodiments, the elastic member is a torsion spring, and the elastic member comprises a pivot portion and two bars at two ends of the pivot portion.

In some embodiments, the first housing comprises a limiting block on the inner wall of the accommodation space, the switch member comprises a stopping block, the bars of the elastic member respectively abut against the limiting block and the stopping block, the switch member further has a shaft hole, and the shaft portion is pivotally connected to the shaft hole.

In some embodiments, the tap portion is movably arranged between a first position and a second position along an axial direction, when the tap portion is at the first position, the tap portion is moved out of the opening, and when the tap portion is at the second position, the tap portion is moved into the opening.

In some embodiments, the first housing comprises a plurality of first teeth and a broken hole at the inner wall of the mating groove, and the hook portion is movably engaged in the mating groove through the broken hole. The first mating portion has an annular recessed portion, and the plug connector comprises a first seal ring fitted over the annular recessed portion. When the second mating portion is fitted over the first mating portion, the first seal ring contacts an inner wall of the second mating portion.

In some embodiments, the first mating portion has a first tubular body, the first conductive terminal is in the first tubular body, the second mating portion has a second tubular body and an outer peripheral portion, and the second conductive terminal is in the second tubular body. The second housing comprises a plurality of second teeth, the second teeth are arranged on an outer wall of the opening adjacent to the second tubular body, and each of the second teeth is engaged with a corresponding one of the first teeth.

In some embodiments, the first housing further comprises an outer cover covering an opening of the accommodation space, the outer cover covers one of two faces of the switch member, and the elastic member is arranged on the other face of the switch member.

In some embodiments, the first housing comprises a first threaded portion, the first threaded portion has a recessed portion, and the plug connector comprises a first waterproof ring at the recessed portion.

In some embodiments, the plug connector further comprises a stand member in the first housing, the stand member comprises a supporting plate and a sleeve member outward extending from a side end of the supporting plate, the sleeve member penetrates the first threaded portion, a surface of the supporting plate has two holes, and the first conductive terminal is connected to one of the two holes.

In some embodiments, the energy-storage connector assembly further comprises a crimp ring, a waterproof gasket, and an outer tubular member. The crimp ring is fitted over the sleeve member, one of two ends of the waterproof gasket is mated with the crimp ring, the outer tubular member has a second threaded portion adapted to be threaded with the first threaded portion, the outer tubular member encloses the crimp ring and the waterproof gasket, an inner annular portion is in the outer tubular member, and the inner annular portion presses against the other end of the waterproof gasket.

In some embodiments, an outer peripheral surface of the crimp ring has a plurality of slots and a plurality of protrusions alternately arranged, and the protrusions contact an inner wall of the outer tubular member.

According to one or some embodiments, the switch member and the elastic member are provided in the first housing of the plug connector, and the tap portion of the switch member can be rotated and tapped, so that the hook portion of the switch member can be movably engaged with or detached from the receptacle connector. Therefore, the locking between the plug connector and the receptacle connector can be released easily and conveniently. Moreover, upon the receptacle connector is mating with the plug connector, the second teeth protruding beyond the outer wall of the receptacle connector are engaged with the first teeth on the inner wall of the mating groove of the plug connector firstly, so that the first conductive terminal and the second conductive terminal can properly contact each other without being twisted. Furthermore, through the arrangement among the crimp ring, the waterproof gasket, and the outer tubular member of the plug connector, tight-seal waterproof function can be achieved by pressing components arranged along the axial direction of the plug connector, so that the components are not prone to be damaged and deteriorated due to overpressure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to an exemplary embodiment of the instant disclosure, where a plug connector and a receptacle connector are mated with each other;

FIG. 2 illustrates an exploded view of the connector assembly according to the exemplary embodiment of the instant disclosure, where the plug connector and the receptacle connector are to be mated with each other;

FIG. 3 illustrates a front exploded view of a plug connector according to an exemplary embodiment of the instant disclosure;

FIG. 4 illustrates a back exploded view of the plug connector according to the exemplary embodiment of the instant disclosure;

FIG. 5 illustrates a schematic view of the plug connector according to an exemplary embodiment of the instant disclosure, where when the switch member of the plug connector is at a first position, the tap portion is out of the opening, and the hook portion is engaged into the mating groove through the broken hole;

FIG. 6 illustrates a schematic view of the plug connector according to an exemplary embodiment of the instant disclosure, where when the switch member of the plug connector is at a second position, the tap portion is in the opening, and the hook portion is detached from the mating groove through the broken hole;

FIG. 7 illustrates a schematic cross-sectional view of a position 7-7 in FIG. 1;

FIG. 8 illustrates a schematic cross-sectional view of a position 8-8 in FIG. 1;

FIG. 9 illustrates a schematic cross-sectional view of a position 9-9 in FIG. 1; and

FIG. 10 illustrates a perspective view of the plug connector according to an exemplary embodiment of the instant disclosure, showing the crimp ring and the waterproof gasket are mated with each other.

### DETAILED DESCRIPTION

To enable persons having ordinary skills in the art to better understand and implement, the purposes, technical features, and advantages of the instant disclosure, the technical features and implementation methods of the instant disclosure are described in detail in the following paragraphs in conjunction with the accompanying drawings, and preferred embodiments are enumerated for further illustration. However, the following embodiments are not intended to limit the claim scope of the instant disclosure, and the drawings referenced in the following paragraphs are schematic representations related to the features of the instant disclosure. To provide a clearer explanation, in the schematic drawings provided herein, the first axis X represents the X-axis of a three-dimensional coordinate system, the second axis Y represents the Y-axis of the three-dimensional coordinate system, and the third axis Z represents the Z-axis of the three-dimensional coordinate system. Regarding the term related to “connections” described in the following embodiments, unless specifically stated as electrical connections, the connections may be physical connections, or refer to direct or indirect connections between physical components.

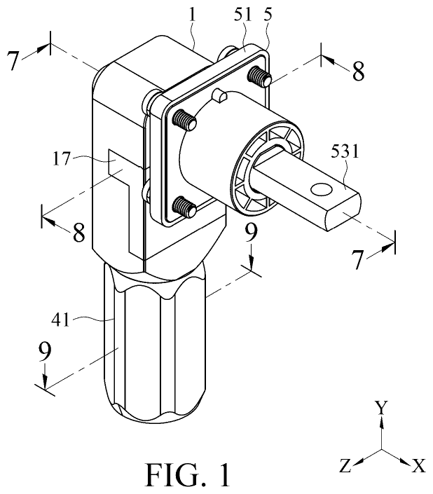

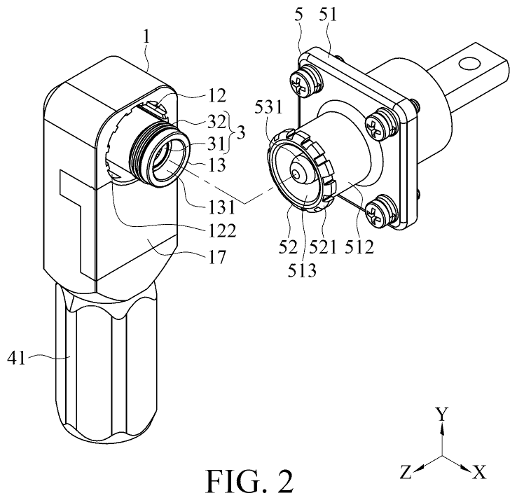

Please refer to FIG. 1 and FIG. 2. FIG. 1 illustrates a perspective view of a connector assembly, where a plug connector 100 and a receptacle connector 200 are mated with each other. FIG. 2 illustrates an exploded view of the connector assembly, where the plug connector 100 and the receptacle connector 200 are to be mated with each other. The plug connector 100 and the receptacle connector 200 are connected to respective transmission cables. The plug connector 100 and the receptacle connector 200 are utilized in solar energy chassis, in which after the plug connector 100 and the receptacle connector 200 are mated with each other, electricity converted from solar energy can be transmitted and stored. The plug connector 100 comprises a first housing 1, a locking component 2, and a first conductive terminal 31. The receptacle connector 200 comprises a second housing 5 and a second conductive terminal 531.

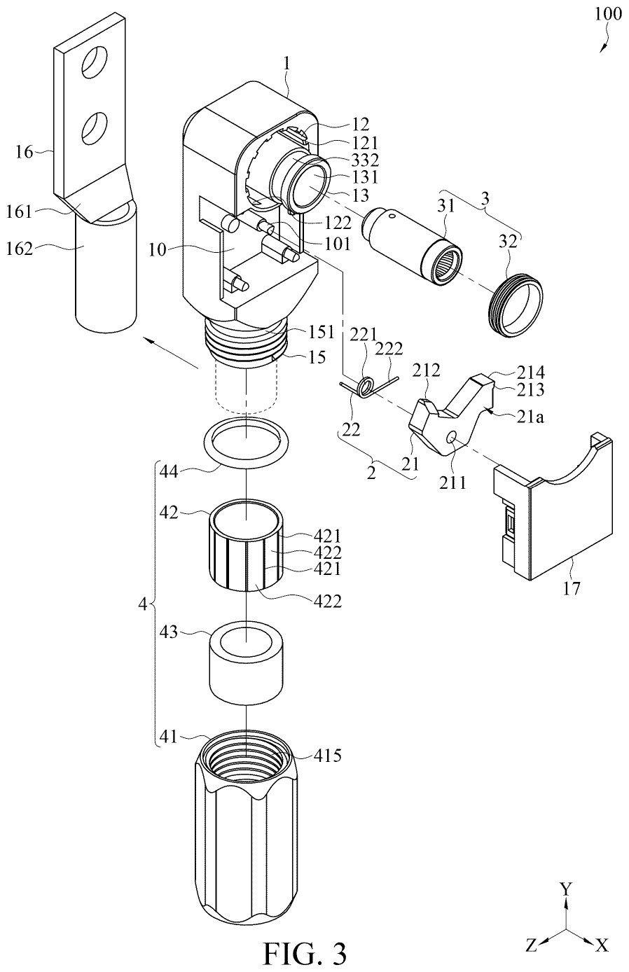

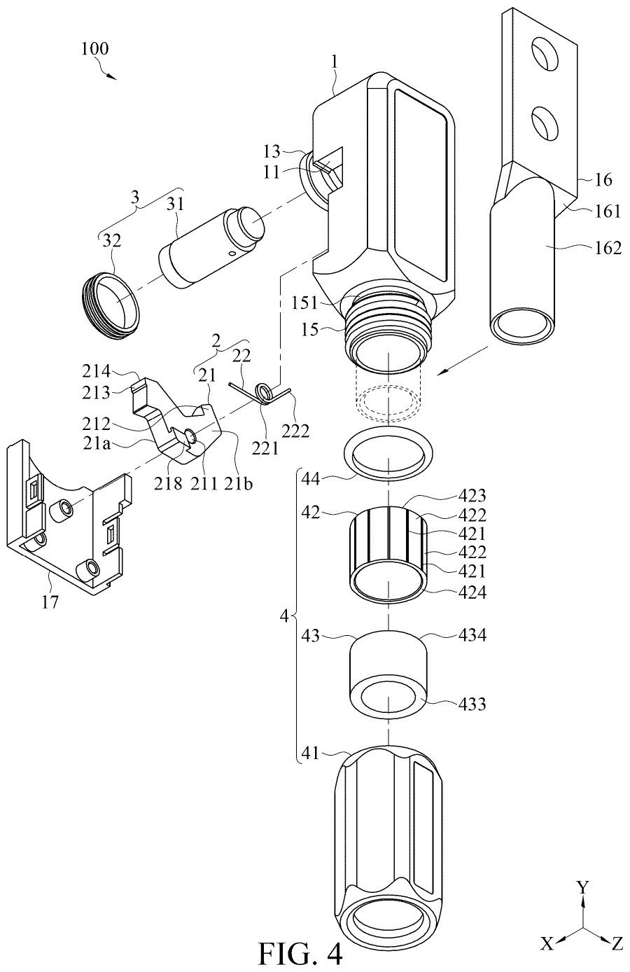

Please refer to FIG. 1 to FIG. 4. FIG. 3 illustrates a front exploded view of the plug connector 100. FIG. 4 illustrates a back exploded view of the plug connector 100. A side surface of the first housing 1 of the plug connector 100 along the first axis (X direction) comprises an accommodation space 10, a mating groove 12, a first mating portion 13, and a shaft portion 101. The accommodation space 10 is approximately located in a middle position of the first housing 1, the mating groove 12 is in communication with the accommodation space 10 and is at an upper portion of the first housing 1, the first mating portion 13 is in the mating groove 12, and the shaft portion 101 is in the accommodation space 10. The shaft portion 101 is arranged along the first axis (X direction), and a side surface of the first housing 1 along the third axis (Z direction) has an opening 11.

The locking component 2 comprises a switch member 21 and an elastic member 22. The switch member 21 and the elastic member 22 are in the accommodation space 10. Two ends of the switch member 21 respectively comprise a hook portion 212 and a tap portion 213, and the tap portion 213 has an acute corner 214.

The first housing 1 of the plug connector 100 is approximately configured as an elongated shell, and the first housing 1 comprises a mating groove 12 recessed along the first axis (X direction) and a first mating portion 13 in the mating groove 12. The second housing 5 of the receptacle connector 200 comprises a base portion 51 and a second mating portion 512 outward protruding beyond a side surface of the base portion 51. In some embodiments, the first mating portion 13 has a first tubular body 131, and the first conductive terminal 31 is in the first tubular body 131; the second mating portion 512 has a second tubular body 513 and an outer peripheral portion 52, and the second conductive terminal 531 is in the second tubular body 513.

After the plug connector 100 is mated with the receptacle connector 200, the second mating portion 512 is inserted into the mating groove 12, so that the second mating portion 512 is fitted over the first mating portion 13, and the first conductive terminal 31 contacts the second conductive terminal 531. In some embodiments, the tap portion 213 is movably arranged between a first position and a second position. When the tap portion 213 is at the first position, the tap portion 213 is moved out of the opening 11; when the tap portion 213 is at the second position, the tap portion 213 is moved into the opening 11. In other words, in this embodiment, in the case that the switch member 21 is at the first position (when the switch member 21 is in the original state), the hook portion 212 of the switch member 21 is engaged with the mating groove 12 through the broken hole 122 so as to lock the second mating portion 512, so that the mating between the plug connector 100 and the receptacle connector 200 can be firmly fixed and thus the plug connector 100 and the receptacle connector 200 cannot be detached from each other easily. Moreover, the acute corner 214 of the tap portion 213 is exposed out of the opening 11.

When a user holds the plug connector 100 with hands, the user can release the locking between the plug connector 100 and the receptacle connector 200 through an easy way. The user can use his or her right thumb to tap the acute corner 214 of the tap portion 213 upward along the second axis (Y direction) (as the direction indicated in FIG. 6), so that the acute corner 214 of the tap portion 213 can be moved into the opening 11 to drive the hook portion 212 to be rotated. Next, the switch member 21 is moved to the second position to be rotated, so that the hook portion 212 is moved from the mating groove 12 through the broken hole 122 and thus is detached from the second mating portion 512. Therefore, the locking between the plug connector 100 and the receptacle connector 200 can be released, and thus the plug connector 100 can be detached from the receptacle connector 200.

Please refer to FIG. 3 and FIG. 4. In some embodiments, the first mating portion 13 has an annular recessed portion 332, a first seal ring 32 is fitted over the annular recessed portion 332. When the second mating portion 512 is fitted over the first mating portion 13, the first seal ring 32 contacts an inner wall of the second mating portion 512.

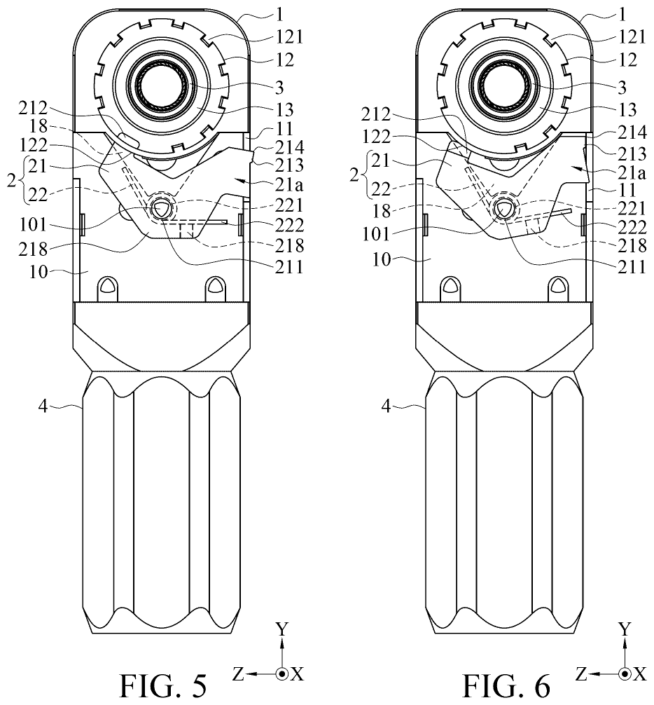

Please refer to FIG. 4 to FIG. 6. In some embodiments, the first housing 1 comprises a limiting block 18 in an inner wall of the accommodation space 10. As shown in FIG. 5, along the first axis (X direction), the limiting block 18 is approximately formed as a V-shaped structure. The switch member 21 has a shaft hole 21, and the shaft hole 211 is pivotally connected to the shaft portion 101. The switch member 21 comprises a stopping block 218, and the stopping block 218 is arranged along a direction facing the inner wall of the accommodation space 10. In some embodiments, the elastic member 22 is a torsion spring. The elastic member 22 comprises a pivot portion 221 and two bars 222 at two ends of the pivot portion 221. The bars 222 at two ends of the elastic member 22 respectively abut against the limiting block 18 and the stopping block 218. Therefore, through the elastic force provided by the elastic member 22, the switch member 21 can be operated as a lever (or a seesaw). Please refer to FIG. 3 and FIG. 4. In some embodiments, the mating groove 12 is round, and an inner wall of the mating groove 12 has a plurality of first teeth 121 and a broken hole 122. The number of the first teeth 121 is ten, and a spacing angle between two adjacent first teeth 121 is about 30 degrees, but the instant disclosure is not limited thereto. The broken hole 122 is between two teeth among the first teeth 121 (that is, in this embodiment, the broken hole 122 is at a position where the teeth are not configured). The number and the angular arrangement of the first teeth 121 ensures that first teeth to have sufficient structural strength. The second housing 5 comprises a plurality of second teeth 521 arranged on the outer peripheral portion 52. The number of the second teeth 521 is twelve, and a spacing angle between two adjacent second teeth 521 is about 30 degrees, but the instant disclosure is not limited thereto. The second teeth 521 are arranged on an outer wall of the opening 11 adjacent to the second tubular body 513, and each of the second teeth 521 is engaged with a corresponding one of the first teeth 121.

It is realized that, the configuration that the number of the first teeth 121 is 10 and the spacing angle between two adjacent first teeth 121 is 30 degrees is merely for illustrative purposes; in some other embodiments, the number of the first teeth 121 is four (or other integers), and the spacing angle between two adjacent first teeth 121 is about 90 degrees.

Please refer to FIG. 3 and FIG. 4. In some embodiments, the first housing 1 comprises an outer cover 17 covering an opening of the accommodation space 10. The outer cover 17 covers the face 21a of the switch member 21, and the elastic member 22 is arranged on the face 21b of the switch member 21.

Please refer to FIG. 3 and FIG. 4. In some embodiments, the first housing 1 comprises a first threaded portion 15. The first threaded portion 15 is a tubular body with outer threaded patterns, and the tubular body outward extends from the bottom portion of the first housing 1 along the second axis (Y direction). The first threaded portion 15 has a recessed portion 151 which is annularly arranged, and the recessed portion 151 is arranged adjacent to the bottom portion of the first housing 1. The plug connector 100 comprises a first waterproof ring 44 at the recessed portion 151.

Please refer to FIG. 3 and FIG. 4. In some embodiments, the plug connector 100 further comprises a stand member 16 in the first housing 1, and the stand member 16 may be combined with the first housing 1 during injection molding process. The stand member 16 comprises a supporting plate 161 arranged along the third axis (Z direction) and a sleeve member 162 outward extending from a side end of a bottom portion of the supporting plate 161 along the second axis (Y direction). The sleeve member 162 penetrates the first threaded portion 15 (as the dashed line shown in FIG. 3). The first threaded portion 15 is adapted to be connected to a transmission cable. A surface of the supporting plate 161 has two holes, and the first conductive terminal 31 is connected to one of the two holes.

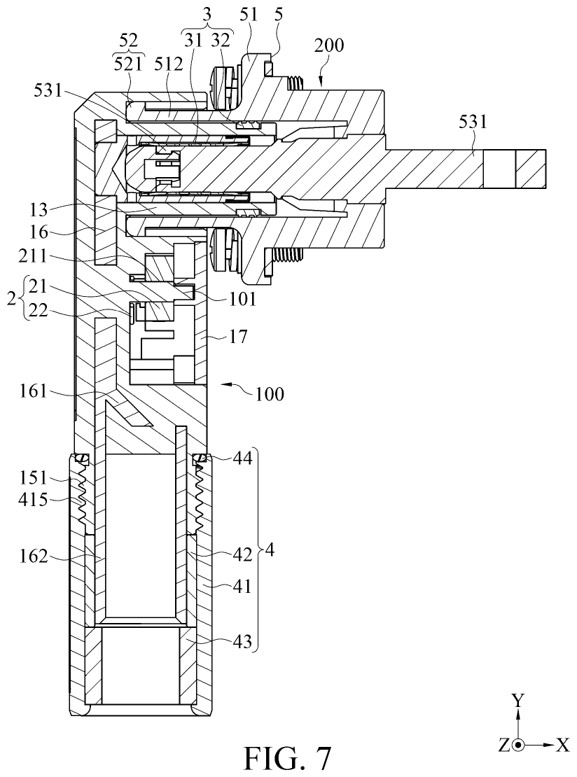

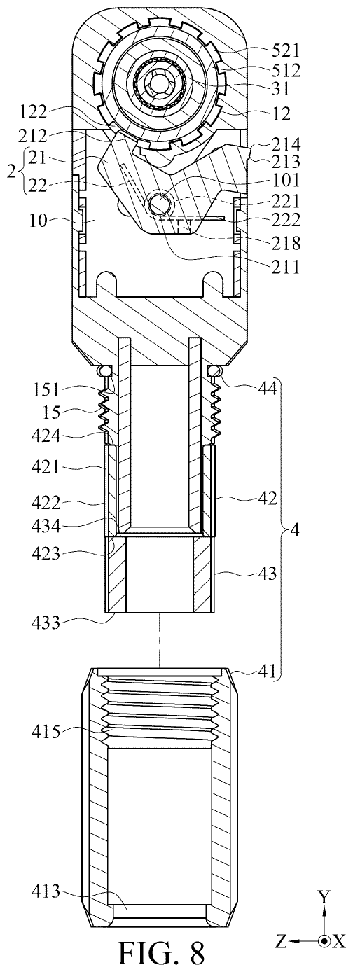

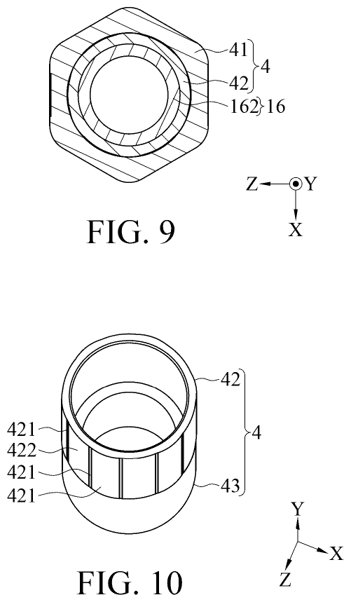

Please refer to FIG. 3, FIG. 6, FIG. 7, FIG. 8, and FIG. 9. In some embodiments, the energy-storage connector assembly further comprises a crimp ring 42, a waterproof gasket 43, and an outer tubular member 41. A thickness of the crimp ring 42 is less than a thickness of the waterproof gasket 43. The crimp ring 42 is fitted over the sleeve member 162, two ends of the crimp ring 42 respectively have a first end surface 423 and a second end surface 424, and two ends of the waterproof gasket 43 respectively have a first end surface 433 and a second end surface 434. The outer tubular member 41 has a second threaded portion 415 adapted to be threaded with the first threaded portion 15. The outer tubular member 41 encloses the crimp ring 42 and the waterproof gasket 43, and an inner annular portion 413 is in the outer tubular member 41. The inner annular portion 413 presses against the first end surface 433 of the waterproof gasket 43, the second end surface 424 of the crimp ring 42 presses against the second end surface 434 of the waterproof gasket 43, and the first end surface 423 of the crimp ring 42 contacts the first threaded portion 15.

Please refer to FIG. 3, FIG. 4, and FIG. 10. In some embodiments, the outer peripheral surface of the crimp ring 42 has a plurality of slots 421 and a plurality of protrusions 422 alternately arranged. The protrusions 422 are curved, a top portion of the outer surface of each of the protrusions 422 contacts an inner wall of the outer tubular member 41, and each of the protrusions 422 contacts the inner wall of the outer tubular member 41 in a linear contact manner.

As above, according to one or some embodiments, the switch member 21 and the elastic member 22 are provided in the first housing 1 of the plug connector 100, and the tap portion 213 of the switch member 21 can be rotated and tapped, so that the hook portion 212 of the switch member 21 can be movably engaged with or detached from the receptacle connector 200. Therefore, the locking between the plug connector 100 and the receptacle connector 200 can be released easily and conveniently. Moreover, upon the receptacle connector 200 is mating with the plug connector 100, the second teeth 521 protruding beyond the outer wall of the receptacle connector 200 are engaged with the first teeth 121 on the inner wall of the mating groove 12 of the plug connector 100 firstly, so that the first conductive terminal 31 and the second conductive terminal 531 can properly contact each other without being twisted. With such configuration, the component has a simple appearance and reduced manufacturing costs. Furthermore, through the arrangement among of the crimp ring 42, the waterproof gasket 43, and the outer tubular member 41 of the plug connector 100, tight-seal waterproof function can be achieved by pressing components arranged along the axial direction of the plug connector 100, so that the components are not prone to be damaged and deteriorated due to overpressure.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An energy-storage connector assembly comprising:
a plug connector comprising:
a first housing comprising an accommodation space, a mating groove in communication with the accommodation space, a first mating portion in the mating groove, and a shaft portion in the accommodation space, wherein a side surface of the first housing has an opening;
a locking component comprising a switch member and an elastic member, the switch member and the elastic member are in the accommodation space, two ends of switch member respectively comprise a hook portion and a tap portion, the hook portion is movably engaged in the mating groove, the tap member is movably exposed from the opening, the switch member and the elastic member are pivotally connected to the shaft portion, respectively, the elastic member is between the switch member and an inner wall of the accommodation space, and two ends of the elastic member respectively abut against the inner wall of the accommodation space and the switch member; and
a first conductive terminal retained in the first mating portion; and
a receptacle connector comprising:
a second housing comprising a base portion and a second mating portion outward protruding beyond a side surface of the base portion, wherein the second mating portion is adapted to be inserted into the mating groove and to be movably engaged with the hook portion; and
a second conductive terminal retained in the second mating portion and is adapted to contact the first conductive terminal.

2. The energy-storage connector assembly according to claim 1, wherein the elastic member is a torsion spring, the elastic member comprises a pivot portion and two bars at two ends of the pivot portion, the first housing comprises a limiting block on the inner wall of the accommodation space, the switch member comprises a stopping block, the bars of the elastic member respectively abut against the limiting block and the stopping block, the switch member has a shaft hole, and the shaft portion is pivotally connected to the shaft hole.

3. The energy-storage connector assembly according to claim 2, wherein the tap portion is movably arranged between a first position and a second position along an axial direction, when the tap portion is at the first position, the tap portion is moved out of the opening, and when the tap portion is at the second position, the tap portion is moved into the opening.

4. The energy-storage connector assembly according to claim 1, wherein the first housing comprises a plurality of first teeth and a broken hole, the hook portion is movably engaged in the mating groove through the broken hole, the first mating portion has an annular recessed portion, the plug connector comprises a first seal ring fitted over the annular recessed portion, and when the second mating portion is fitted over the first mating portion, the first seal ring contacts an inner wall of the second mating portion.

5. The energy-storage connector assembly according to claim 4, wherein the first mating portion has a first tubular body, the first conductive terminal is in the first tubular body, the second mating portion has a second tubular body and an outer peripheral portion, the second conductive terminal is in the second tubular body, the second housing comprises a plurality of second teeth, the second teeth are arranged on an outer wall of the opening adjacent to the second tubular body, and each of the second teeth is engaged with a corresponding one of the first teeth.

6. The energy-storage connector assembly according to claim 1, wherein the first housing further comprises an outer cover covering an opening of the accommodation space, the outer cover covers one of two faces of the switch member, and the elastic member is arranged on the other face of the switch member.

7. The energy-storage connector assembly according to claim 1, wherein the first housing comprises a first threaded portion, the first threaded portion has a recessed portion, and the plug connector comprises a first waterproof ring at the recessed portion.

8. The energy-storage connector assembly according to claim 7, wherein the plug connector further comprises a stand member in the first housing, the stand member comprises a supporting plate and a sleeve member outward extending from a side end of the supporting plate, the sleeve member penetrates the first threaded portion, a surface of the supporting plate has two holes, and the first conductive terminal is connected to one of the two holes.

9. The energy-storage connector assembly according to claim 7, further comprising a crimp ring, a waterproof gasket, and an outer tubular member, wherein the crimp ring is fitted over a sleeve member, one of two ends of the waterproof gasket is mated with the crimp ring, the outer tubular member has a second threaded portion adapted to be threaded with the first threaded portion, the outer tubular member encloses the crimp ring and the waterproof gasket, an inner annular portion is in the outer tubular member, and the inner annular portion presses against the other end of the waterproof gasket.

10. The energy-storage connector assembly according to claim 9, wherein an outer peripheral surface of the crimp ring has a plurality of slots and a plurality of protrusions alternately arranged, and the protrusions contact an inner wall of the outer tubular member.
